(19) United States
(12) Patent Application Publication
(10) Pub. No.: US 2026/0072777 A1
(43) Pub. Date: Mar. 12, 2026

(54) DYNAMICALLY CONFIGURED INCIDENT LOG COLLECTION

(71) Applicant: Dell Products, L.P., Round Rock, TX (US)

(72) Inventors: Apu Mandal, Plymouth, MN (US); Peter Kilner, Boulder, CO (US); Jack Eby, Burien, WA (US); Britney Carrier, Marysville, WA (US); Scott Aylward, Federal Way, WA (US)

(21) Appl. No.: 18/882,848

(22) Filed: Sep. 12, 2024

(51) Int. Cl. G06F 11/07

(52) U.S. Cl. CPC G06F 11/079; G06F 11/0709; G06F 11/3006; G06F 11/301; G06F 11/3072

(57) ABSTRACT

The described technology is generally directed towards dynamically, and automatically, identifying, for a current issue, a previously implemented investigation having the same, or substantially similar content/conditions to the current issue, and further implementing knowledge derived during the prior investigation to determine a cause of the current issue. In the event of implementing a scope of investigation of the prior investigation does not enable the cause of the current issue to be resolved, expanding the scope of the current investigation to enable the cause of the current issue to be identified. The current issue can occur on a node, a node service, etc., and the respective scope of investigation generates a logset identifying one or more conditions of operation of the node when the current issue occurred, and devices/services to be reviewed.

### BACKGROUND

In response to an incident/issue arising at a data system, to assist in troubleshooting the incident, a data gather operation can be instigated, where the data gather operation performs a system-wide data trawl gathering as much pertinent information as possible to facilitate troubleshooting of the incident. To enable analysis of the root cause of the incident, the data gather operation scans through numerous area components, across multiple nodes, to generate a logset that is comprehensive in nature.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to automatically and dynamically identify and implement a gather profile matching, or substantially similar to, one or more conditions pertaining to a current issue. The identified gather profile can be used to define a scope of a logset gather for the current issue.

According to one or more embodiments, a system is presented, wherein the system comprises at least one processor, and at least one memory coupled to the at least one processor and having instructions stored thereon, wherein, in response to the at least one processor executing the instructions, the instructions facilitate performance of operations, comprising receiving an indication of an issue occurring on a component, wherein the indication of the issue comprises a first signature identifying a first condition regarding the incident, further identifying a first gather profile comprising a second signature comparable to the first signature according to a defined similarity criterion, wherein the first gather profile has a first scope of data collection, and further implementing a first logset gather for the issue, wherein the first logset gather has a second scope of data collection, and wherein the second scope of data collection is a function of the first scope of data collection.

In an embodiment, the component can be a node located in a data server. In another embodiment, the first gather profile can be generated based on a prior issue determined to have occurred at the node. In a further embodiment, the first gather profile can be generated based on a prior issue determined to have occurred at a service hosted on the node.

In another embodiment, the first gather profile identifies at least one action to be performed during implementation of the first logset gather during investigation of the incident.

In a further embodiment, the operations can further comprise determining that implementation of the first logset gather failed to determine a root cause of the incident, further generating a second logset gather having a third scope of data collection, wherein the third scope of data collection is an expansion of scope associated with the second scope of data collection, and further implementing the second logset gather for the incident.

In another embodiment, the second scope of data collection can comprise a first duration of time based on a first time when the incident occurred, wherein the third scope of data collection can comprise a second duration of time based on a second time when the incident occurred, and wherein the second duration of time exceeds the first duration of time.

In a further embodiment, the second scope of data collection can comprise a first collection of devices to be investigated, and wherein the first collection of devices can comprise at least one node, at least one service, at least one configuration, or at least one core.

In another embodiment, the third scope of data collection can comprise the second scope of data collection, and wherein the at least one node, the at least one service, the at least one configuration, or the at least one core are not within scope of the second scope of data collection.

In further embodiments, a computer-implemented method is provided, wherein the method comprises generating, by a device comprising at least one processor, a first profile, wherein the first profile comprises a first scope of investigation implemented during resolving a first issue at a node and first content pertaining to a cause of the first issue, further receiving, by the device, a notification of a second issue arising at the node, wherein the second issue is accompanied with second content detailing one or more conditions of the node when the issue arose, and further determining, by the device, the second content is substantially similar to the first content. In a further embodiment, the method can further comprise facilitating, by the device, implementing the first profile to compile a logset regarding operation of the node when the second issue occurred.

In another embodiment, the computer-implemented method can further comprise reviewing, by the device, the logset to determine a root cause of the second issue. In an embodiment, the computer-implemented method can further comprise, in the event of identifying, by the device, the root cause of the second issue, adding, by the device, the second content of the second issue to information pertaining to the first profile.

In a further embodiment, the computer-implemented method can further comprise, in the event of identifying, by the device, the root cause of the second issue, generating, by the device, a second profile, wherein the second profile comprises information representative of the second scope of investigation, the second issue, and the root cause of the second issue.

In another embodiment, the computer-implemented method can further comprise, in the event of not identifying, by the device, the root cause of the second issue, generating, by the device, a second scope of investigation, wherein the second scope increases, relative to the first scope of investigation, at least one of a duration of time of investigation, number of nodes to be reviewed during investigation, number of services to be reviewed during investigation, number of configurations to be reviewed during investigation, number of cores to be reviewed during investigation, or number of logs to be reviewed during investigation.

In an embodiment, the first issue and the second issue can occur on a same node located in a data server.

In a further embodiment, the first scope of the first profile can be utilized to compile the logset regarding operation of the node at a time when the second issue occurred.

Further embodiments can include a computer program product stored on a non-transitory computer-readable medium and comprising machine-executable instructions, wherein in response to being executed, the machine-executable instructions cause a system to perform operations, comprising (a) receiving notification of a first issue occurring with respect to a component, wherein the notification of the first issue can comprise a first signature identifying a first condition regarding the first issue, (b) identifying a first gather profile having a second signature determined to be threshold similar to the first signature, wherein the first gather profile can be generated based on a prior root cause analysis of a second issue, and wherein the first gather profile can have a first scope of data collection, and (c) implementing a first logset gather for the issue, wherein the first logset gather can have a second scope of data collection, and the second scope of data collection can be defined based on the first scope of data collection. In an embodiment, the component can be a node located in a data server.

In an embodiment, the second issue occurred on at least one of a node in a data network system or a service hosted on the node in the data network system. In another embodiment, the first scope of data collection can comprise at least one of a one node, a service, a configuration, or a core reviewed during the prior root cause analysis of the second issue.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1A presents a schematic of an example system configured to generate an incident logset based on a defined scope of a gather profile, in accordance with one or more embodiments.

FIG. 1B presents an example schematic further developing concepts and embodiments presented regarding the logset gather system presented in FIG. 1A, in accordance with one or more embodiments.

FIG. 2 presents a table illustrating an example issue log, populated in accordance with one or more embodiments presented herein.

FIG. 3 presents a flowchart of an example computer-implemented method for dynamically implementing a gather profile and associated investigative scope to address an issue, in accordance with one or more embodiments.

FIG. 4 presents a flowchart of an example computer-implemented method for dynamically implementing a gather profile and associated investigative scope to address an issue, in accordance with one or more embodiments.

FIG. 5 presents a flowchart of an example computer-implemented method for automatically and dynamically implementing one or more gather profiles to enable identifying a root cause of an issue, in accordance with an embodiment.

FIG. 6 presents a flowchart of an example computer-implemented method for automatically and dynamically implementing one or more gather profiles to enable identifying a root cause of an issue, in accordance with an embodiment.

FIG. 7 presents a flowchart of an example computer-implemented method for automatically and dynamically implementing one or more gather profiles to enable identifying a root cause of an issue, in accordance with an embodiment.

FIG. 8 illustrates an example wireless communication system, in accordance with one or more embodiments described herein.

FIG. 9 presents an example environment for implementing various embodiments presented herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is to be appreciated, however, that the various embodiments can be practiced without these specific details, e.g., without applying to any particular networked environment or standard. In other instances, well-known structures and devices are shown in block diagram form in order to facilitate describing the embodiments in additional detail.

### 1. Overview

As previously mentioned, upon an issue arising at a conventional system, system health monitoring software is available to alert a system administrator to investigate and resolve the issue. The system administrator may be local to the data system, e.g., the system administrator is an employee of the company utilizing the data system. However, issues are often not easy to resolve, and the system administrator may have to generate/open a service ticket request to engage the assistance of customer/technical support at a backend system. The technical support can be an employee of a company providing the data system, with the data system provider being a different company to the data system customer.

Generally, in attempting to resolve the issue, customer support requests a log gather (a.k.a. a logset) from the system of concern, whereby the logset functions as a foundation for further investigation to diagnose and resolve the issue. The size and complexity of a logset can reflect the size of the system at which the issue arose. For example, for an issue arising on a large cluster system, generation and uploading of the log gather/logset can take an extended period of time due to the large size of the logset itself. For example, in a large scaled out system such as an extensive network-attached storage system (NAS), generation, compilation, transfer, and/or processing of the logset can potentially take hours before analysis can be undertaken. The inherent delays can negatively impact time to resolution (TTR), service agreements, and overall customer satisfaction. Increased cluster size, e.g., as new servers are added to the data system, amplifies size/scope of the logset. Further, valuable system resources/extensive network bandwidth may be consumed to store and/or transfer the logset. Furthermore, multiple gathers can result in a huge amount of duplicated redundant information to be collected for each issue occurrence. Further, logsets are generally not mutable, with an original, collected logset required to be maintained for accountability, along with any other pertinent business reasons.

Generation of a logset via a conventional approach may entail a system wide log collection with additional high-level filtering options. Filtering is not commonly used, and may require advanced knowledge of the system internals. Even if filtering is applied, the logset baseline itself may be large.

Typically, service engineers extract the logset manually or via a log processing system, with the investigation being focused/centered on navigation of the application logs and configuration information available in the logset. Analysis can be a manual process of parsing one or more logs from the vast logset collection, and further diagnosing an issue. In an extensive cluster system, the investigation can be a large and laborious effort to identify traces to determine one or more root causes of the issue, with the investigation parsing through a large dataset, e.g., where logs are collected for each service from all the nodes within the cluster. Issues may be quickly diagnosed with one or more key application logs related to the incident, but edge cases can exist where it would require a full system gather including cores and other data to root cause the underlying issue. Root causing the issue can be a challenge as the investigation has to comb through many different application logs, e.g., both at the node and cluster level. An incident could arise due to a cascade effect, and the investigation will have to scan through many area components, across numerous nodes, etc., to root cause the issue.

The various embodiments presented herein relate to conducting an efficient, precise, and relevant gather operation at the source of the issue without compromising analysis of the issue while enabling tech support to provision a quick/expedited diagnosis. The one or more embodiments relate to taking advantage of the specific knowledge/data pertaining to the issue coupled with a focused investigation to diagnose an issue, rather than the conventional approach requiring an extensive log gather and creation of a corresponding large logset.

An intelligent gather operation can be performed, being specific to the incident, driven by context provided by a gather profile, e.g., in conjunction with auto determination of a time window for the gather operation to occur.

Over the course of operation of the various nodes, etc., one or more gather profiles can be created and linked to one or more events during development of the gather profiles/systems based on, for example, direct knowledge of subject matter experts (SME). Incidents of concern can be independent and isolated in nature, while other incidents may have dependency across multiple services within the same node or across multiple nodes within a cluster.

With the various embodiments presented herein, a logset gather can be optimized, targeted, granular, and bound to a specific time window pertaining to the incident, thereby keeping the logset small and focused on exactly what a service engineer needs to review. In an embodiment, smart gathering can occur at the source of the issue itself, with the entire gather workflow benefitting from such an approach, such as, in a non-limiting list: a) a smaller size/scope of the gather, b) reduced transfer time, c) less network congestion, d) faster processing time, e) lower storage consumption, and such. A smart gather operation conducted in conjunction with defined gather profiles enables service engineers to focus on key details necessary to diagnose an issue in a shorter period of time, thereby significantly reducing TTR, compared with the conventional approach.

Per the various embodiments presented herein, a smart gather profile can be defined for each identified/potential issue in a system, in conjunction with any associated services connected to the issue. The services can be directly associated with the issue, rather than remotely associated, per a conventional log gather operation. Further, a smart gather profile can have one or more references to other services and issue/event categories which would/may indirectly cause the issue. Accordingly, a dependency tree can be dynamically constructed, leading to a compact, but comprehensive gather, further avoiding requests for multiple gathers for the same incident.

Regarding an issue arising, some issues may be auto triggered from a lower level of the software stack, e.g., per a hardware sensor, while other alerts may be generated through periodic monitoring of the system by a health monitoring framework. Per the various embodiments presented herein, gather profiles can isolate an issue arising, with a time range for the investigation to be deterministically calculated, further enabling an efficient gather to be conducted.

In an embodiment, in response to an issue being raised, the issue can be identified, e.g., with regard to the specifics of the issue, an associated node, service, etc., wherein details regarding the issue can be compared with content of one or more prior gather profiles. In the event of the details of the issue match with a previously generated investigation/gather profile, the prior gather profile can be accessed, with the prior gather profile acting as a map/guide/template to enable subsequent identification of the issue, determination of the scope of the issue, how the issue can be addressed/mitigated, and suchlike.

As further described, each gather profile can be schema-based and tailored to an issue in the system. In an embodiment, a gather profile can be a JSON file configured to capture details about the service components directly associated with the issue in conjunction with an ordered reference list of, for example, dependent service and area components. When an issue/alert is raised, the incident system can be configured to leverage a static gather profile, dynamically scan the system for any active issues in a dependency tree (e.g., associated with the incident and/or the gather profile) and create gather context based on any information gathered during the discovery operation.

In an example scenario of implementation, in the event of an issue arising in a server message block (SMB) protocol area, the issue could, in a non-limiting list, occur in SMB service area itself, relate to an authentication area event, be a network issue affecting a few nodes in a cluster, and suchlike.

A situation can occur where logs are completely rotated and may have been manually removed. In such a situation, collection of the targeted log(s) may not be possible, however, such a situation is no worse than the conventional on-demand gather operation.

However, in the event of logs are available (e.g., are archived/still in the data system), per the embodiments presented herein, a gather profile operation can collect archived logs only pertaining to an auto detected time range for which logs are relevant (a time period from which the issue occurred).

In an embodiment, one or more gather profiles can be independently and dynamically updated, e.g., without the need for a system update/release at one or more nodes or components included in the distributed network file system. Accordingly, automatic, dynamic, and independent updating of one or more gather profiles enables flexibility in operating/maintaining the system, and further enables support and service to tune the system/gather profiles further to achieve a desired goal across the system. A logset generated in accordance with the various embodiments presented herein can be sufficiently small enough to be downloaded and attached to a service request ticket, where such an approach can be particularly useful for dark site customers.

The terms issue, event, incident, and the like, are used interchangeably herein.

### 2. A Gather Profile System

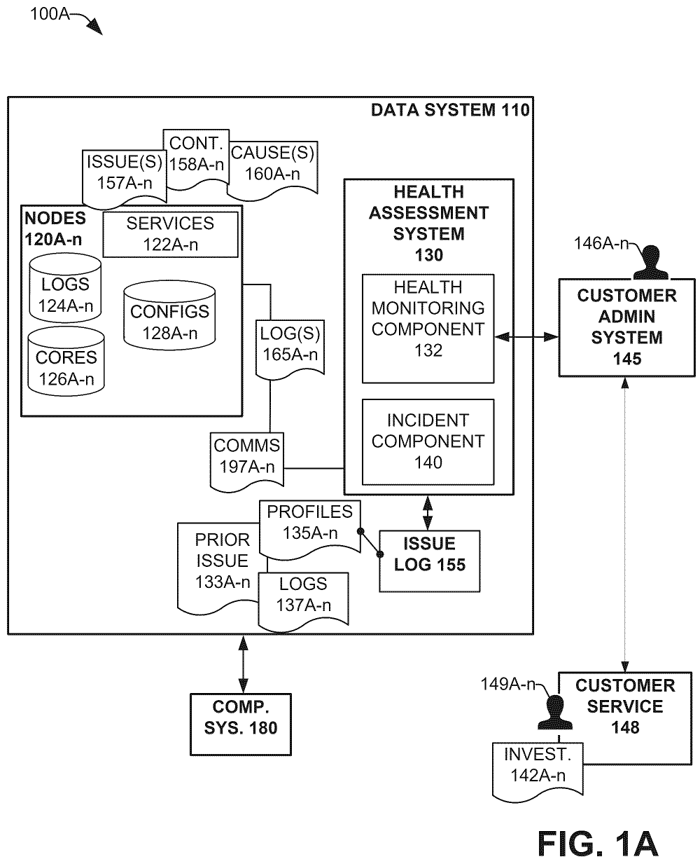

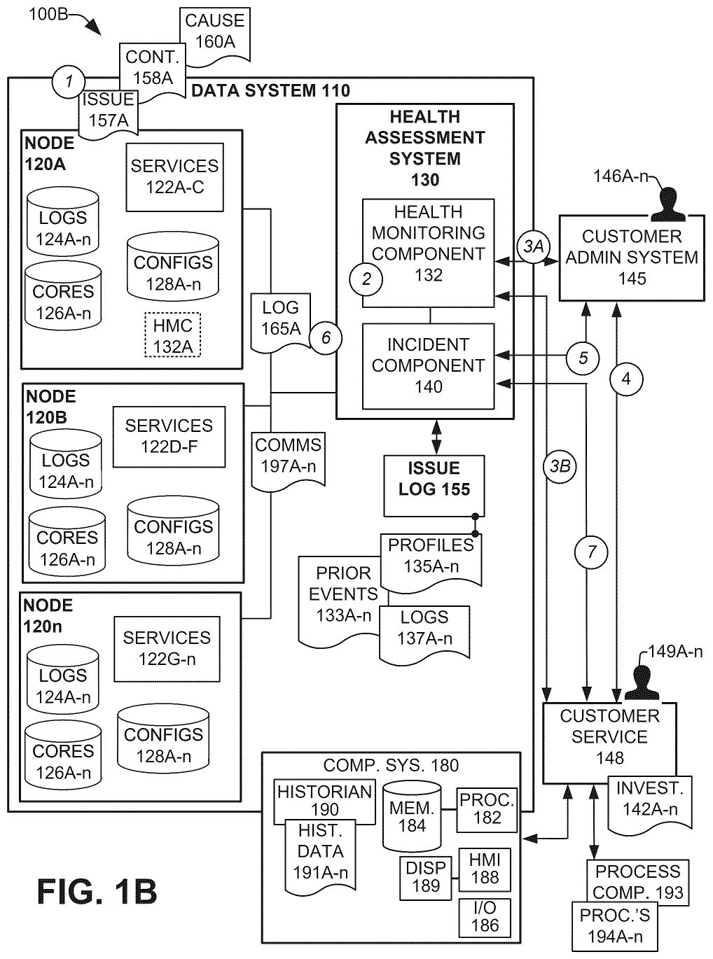

FIG. 1A presents a schematic of an example system 100A configured to generate an incident logset based on a defined scope of a gather profile, in accordance with one or more embodiments. The term n, as used herein, is any positive integer.

As shown, system 100A can include a data system 110 that further includes one or more nodes 120A-n, whereby various workload operations can be performed across data system 110/nodes 120A-n. A workload can relate to an activity associated with processing/hosting data (e.g., in a digital format, code, information) at the data system 110, and the various operations, applications, processes, workflows, computations, analytics, algorithm execution, maintaining, updating, and the like, performed on the data as a function of a client's activity regarding the data. Workload activities can range, for example, from storing and maintaining data on a data server (e.g., on a node 120A-n), through to executing algorithms to analyze and/or modify the data (e.g., as a function of operations performed at a data center and/or remotely), transmission of data, receiving one or more instructions regarding processing of the data, updating data, replicating data, and the like. Data system 110 can comprise any suitable configuration, such as a data server, or other computer-based platform configured to store data, manage data, process data, secure data, and the like.

Nodes 120A-n are respectively configured to host one or more services 122A-n, whereby, a particular node 120A-n can host any number of services 122A-n. Nodes 120A-n can also include any of one or more logs 124A-n detailing operation of a node 120A-n, one or more cores 126A-n configured to coordinate data storage at a node 120A-n, and/or one or more configurations 128A-n of a node 120A-n.

As further shown, data system 110 can further include a health assessment system 130 communicatively coupled to one or more nodes 120A-n, services 122A-n, etc. The health assessment system 130 can be configured to monitor operation of the nodes 120A-n, services 122A-n, etc., and further configured to raise an alarm (e.g., alarm notification 197A-n, as further described) regarding occurrence of an issue 157A-n at a node 120A-n, etc., to facilitate investigation/troubleshooting of issue 157A-n occurring at the respective node 120A-n, etc.

As shown, the health assessment system 130 can include a health monitoring component (HMC) 132 configured to monitor operation of the respective nodes 120A-n, services 122A-n, etc., and in response to an issue 157A occurring, the HMC 132 can further generate a notification 197N (e.g., in communications 197A-n) for further investigation (e.g., in investigation 142A-n) of the issue 157A as further described.

Health assessment system 130 can further include an incident component 140, wherein the incident component 140 can be configured to, in response to an issue 157A occurring, identify a gather profile 135A-n pertaining to the issue 157A. A prior implemented gather profile 135A-n can be identified based on a match/similarity between a prior issue 133A-n and content 158A-n pertaining to the current issue 157A. In a further embodiment, incident component 140 can be further configured to implement the identified gather profile 135A-n, causing a logset 165A to be gathered in accordance with a scope 136A-n of the identified gather profile 135A-n. As further described, the incident component 140 can be further configured to monitor the investigation 142A-n in accordance with the scope 136A-n of the gather profile 135A-n, and dynamically update the scope 136A-n of the gather profile 135A-n (e.g., in an issue log 155) in accordance with an outcome of the investigation 142A-n, e.g., investigation 142A identified a root cause 160A-n, root cause 160A was not identified and further investigation 142A is needed, etc. An investigation 142A-n can be configured based on prior issues 133A-n and prior logsets 137A-n.

As further shown, data system 110 can be communicatively coupled to an administration system 145, wherein the administration system 145 can be operated by an entity 146A-n (e.g., system administrator) associated with the data system 110. A customer service center 148 can also be communicatively coupled to the data system 110 and the administration system 145, wherein customer service center 148 can be operated by an entity 149A-n (e.g., a customer service engineer).

As further described, any of the data system 110, the customer administration system 145, and/or the customer service system 148, and any subcomponents located/operating in any of the systems presented in FIG. 1A, can include/be communicatively coupled to one or more computer systems 180A-n. Further, while investigation 142A-n is shown in FIG. 1A as being conducted at a customer service center 148, the investigation 142A-n can be performed at any of the administration system 145 and/or the customer service center 148, or jointly at both the administration system 145 and/or the customer service center 148.

FIG. 1B presents a schematic of an example system 100B further developing concepts and embodiments presented regarding the logset gather system 100A presented in FIG. 1A, in accordance with one or more embodiments. As shown in FIG. 1B, system 100B includes the data system 110 and included components, the customer administration system 145, customer service system 148, and respective computer systems 180A-n.

Further, regarding operation of the respective components, etc., the following steps 1-8 are provided for understanding of the functionality of the respective components and an example sequence of operation.

At 1, an issue 157A arises at particular node 120A-n, a service 122A-n, and the like, wherein the issue 157A can be detected by the HMC 132. Any suitable approach can be implemented at the HMC 132 to detect an issue 157A-n arising across the nodes 120A-n, services 122A-n, etc. For example, the issue 157A can be detected by HMC 132 as a function of operation of a node 120A-n (e.g., operation of a service 122A-n being hosted at the respective node), wherein HMC 132 can be configured to continuously monitor nodes 120A-n, etc., and further automatically detect the change in operation of/issue 157A occurring the node 120A-n.

In another example, HMC 132 can be configured to periodically monitor operation of the nodes 120A-n and detects the change in operation of the node 120A-n during the periodic monitoring.

In another example, a health monitoring component (as indicated by HMC 132A at node 120A) can be implemented locally at a respective node 120A-n, wherein the health monitoring component can be configured to monitor operation of the local node 120A-n and detect issue 157A occurring.

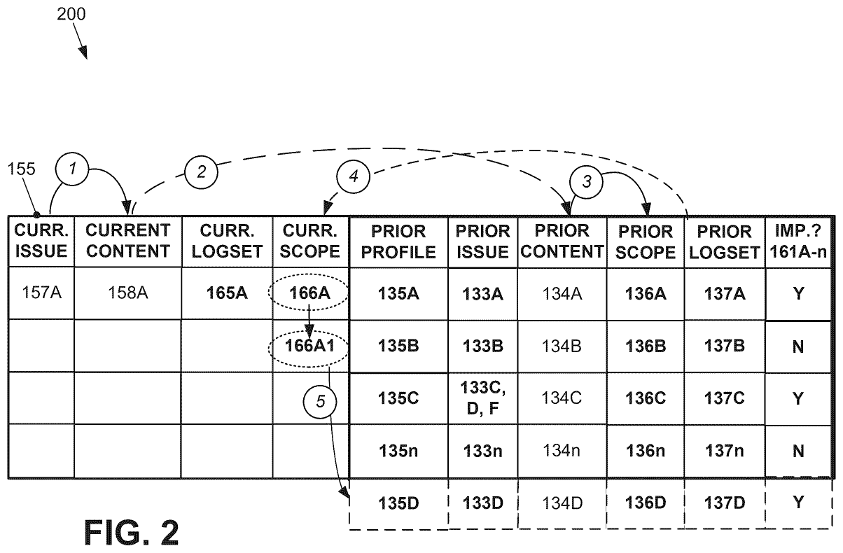

At 2, in response to detecting issue 157A, HMC 132 (and/or HMC 132A) can be configured to populate an issue log 155 (per FIG. 2) with the issue 157A. HMC 132 can be further configured to identify content 158A-n comprising context/information pertaining to issue 157A, such as time of issue 157A occurring, what device/operation has been affected by the issue 157A such as operation of a node 120A-n, service 122A-n, and the like. Content 158A can be applied to issue 157A in issue log 155. In an aspect, as further described, content 158A can function as a signature (e.g., a first signature) of issue 157A. In an example scenario of operation, the issue 157A can be generated by HMC 132A operating locally at the node, e.g., node 120A. In another example scenario, HMC 132 can be configured to determine content 158A regarding issue 157A, e.g., HMC 132 detects an operating condition of node 120A-n has changed from a first, initial status (an expected operating condition of node 120A), to a second status (e.g., operating condition of node 120A when issue 157A arises).

At 3A, HMC 132 can be further configured to generate and transmit an event notification 197A identifying that issue 157A has been detected/occurred. In a first example of operation, HMC 132 can be configured to generate and forward the event notification 197A to the administration system 145/administrator 146A.

At 3B, HMC 132 can be further configured to forward the event notification 197A to the customer service system 148/support engineer 149A. In an aspect, operation of particular nodes 120A-n, services 122A-n, etc., can be identified regarding operational importance (e.g., critical importance). For example, issue log 155 can have an importance parameter 161A-n, wherein the importance can be set as a binary YES/NO, a ranking 1 (low) to 5 (high), and the like. HMC 132 can be configured to detect parameter 161A-n in issue log 155, and any issue 157A-n arising on the nodes 120A-n, etc., defined as critically important can also trigger HMC 132 to forward an event notification 197E to the customer service system 148, e.g., to enable a customer service entity 149A-n to be aware of the issue 157A in readiness to perform troubleshooting of the issue 157A, per investigation 142A-n.

At 4, in response to receiving the event notification 197A (e.g., per step 3A), in an example operation, an entity 146A, at the customer administration system 145, can manually review the event notification 197A to determine whether further action is required. In response to a determination that the issue 157A is potentially important, the customer administration system 145 can be configured to generate and transmit a service request 197S to the customer service system 148. In another example of operation, the customer admin system 145 can be configured to, upon receipt of the event notification 197A, automatically generate and transmit a service request 197S to the customer service system 148. Customer admin system 145 can utilize AI (artificial intelligence) and ML (machine learning) techniques and technologies (e.g., processes 194A-n) to automatically parse the event notification 197A to determine whether the event notification 197A requires review at the customer service system 148 and takes appropriate action (e.g., raises the service request 197A to notify the customer service system 148 to prepare for troubleshooting of the issue 157A).

At 5, the administration system 145 can be further configured to initiate operation of the incident component 140 to enable further investigation (e.g., investigation 142A-n) into a cause(s) of the issue 157A. In an embodiment, the incident component 140 can be configured to compare content 158A of the current issue 157A with content 134A-n previously acquired for one or more previously defined profiles 135A-n. As mentioned, content 158A-n and/or 134A-n can comprise of any information suitable to enable a prior logset 137A-n/gather profile 135A-n to be identified and implemented, wherein, content 158A-n/134A-n can respectively include one or more signatures (e.g., content 134A comprises a second signature), event sequences, timings, node 120A-n at which the issue 157A-n was detected, service 122A-n at which the issue 157A-n was detected, alarms, etc. In response to incident component 140 determines content 158A matches/has substantial similarity to content 134A-n of a profile 135A-n, e.g., content 134A of profile 135A, the incident component 140 can be further configured to extract the matching profile 135A and further initiate a gather operation based on the content/scope 136A-n of the profile 135A.

A gather profile 135A-n can have a scope 136A-n potentially defining a scope of a gather operation to be performed to resolve issue 157A, wherein a scope 136A-n can be defined/constrained by the scope of a prior investigation 142P performed to resolve a prior issue, e.g., scope 136A of prior issue 133A, associated with the profile 135A. Profile 135A, and the scope of 136A, can be based on the scope of the gather log 137A generated during the investigation 142P of the prior issue 133A, such that the extent of the data in the gather log 137A enabled the prior issue 133A to be resolved, e.g., a root cause 160A-n was determined for prior issue 133A.

In an embodiment, one or more gather profiles 135A-n can be generated and function as default gather profiles 135A-n. For example, entity 146A-n and/or entity 149A-n can generate one or more default gather profiles 135A-n in expectation/anticipation that an issue 157A-n may arise, such that a potential issue 157P has a default gather profile 135P created for potential issue 157P. In the event of an issue 157X does arise, and content of issue 157X is threshold similar to the content of a potential issue 157P (which is now functioning as a prior issue 133P), the gather profile 135P can be implemented to define the scope of data gather for issue 157X. Further, in the event of implementing gather profile 135P enables issue 157X to be resolved, any information, etc., derived from investigating issue 157X can be added to content, etc., associated with the gather profile 135P, or alternatively, a new, amended gather profile 135P-1 can be generated in accordance with the information derived from investigating issue 157X. Accordingly, during initial implementation of HAS 130, a default gather profile 135P is available for implementation, and as implementation of HAS 130 proceeds, gather profiles 135P-1, 135P-2, etc., can be generated from the respective investigations.

Per the various embodiments presented herein, a gather profile 135A-n can be generated for a given issue 157A-n/133A-n and stored in the centralized database 155, providing an efficient solution to diagnosing/troubleshooting an issue 157A-n. In another embodiment, the various gather profiles can be deployed in a managed rollout across multiple data systems 110 and any associated HAS's 130A-n, e.g., without requiring any software code update, enabling efficient and comprehensive scale out cluster solution.

At 6, in an example scenario, a gather logset 165A for issue 157A can be obtained/generated based on the identified gather log 137A and scope 136A associated with the identified prior profile 135A. The gather logset 165A can compile/include data/information regarding operation of a node 120A-n, a service 122A-n, a log 124A-n, a core 126A-n, and/or a configuration 128A-n identified by the scope 136A of the prior profile 135A.

At 7, with logset 165A obtained, further investigation (e.g., per investigation 142A-n) can be performed to determine event 160A, wherein event 160A is the root cause of issue 157A. For example, during execution of investigation 142A-n, either of service engineer 149A or the system administrator 146A can manually analyze the logset 165A to identify an event 160A that is the root cause of issue 157A. Alternatively, the customer admin system 145 and/or the customer service system 148 can be configured to utilize AI and/or ML technologies (e.g., via process component 193 and one or more processes 194A-n, as further described) to determine whether the root cause event 160A of the issue 157A can be determined from the logset 165A. In the event of analysis (manual and/or automated) of the logset 165A is able to determine the event 160A causing the issue 157A, content 134A of profile 135A can be supplemented with the issue 157A, event 160A, and content 158A associated with issue 157A, thereby extending the knowledge associated with profile 135A to enable further/subsequent matching of a content 158A-n pertaining to a subsequent issue 157A-n to content 134A-n or a prior issue 133A-n.

As further described, in the event of gather profile 135A, with scope 136A, is determined by the incident component 140 to be a good fit for defining the current scope 166A of the gathering of the current logset 165A, and yet, the investigation 142A into the cause of the issue 157A fails to identify a root cause event 160A-n of the issue 157A, current scope 166A can be extended, such that a second/subsequent scope 166A-1 can be generated from initial scope 166A. For example, scope 166A can comprise a first collection of devices/components/data to be investigated, wherein the first collection of devices, etc., can include at least one node 120A-n, at least one service 122A-n, at least one core 126A-n, or at least one configuration 128A-n, while scope 166A-1 can include devices, etc., included in scope 166A and additionally at least one node 120A-n, at least one service 122A-n, at least one core 126A-n, at least one configuration 128A-n, and the like, not included in scope 166A. In another example, where scope 166A comprises a first duration of time (e.g., a first duration of time after issue 157A arose/was detected), scope 166A-1 can comprise a second duration of time (e.g., a second duration of time after issue 157A arose/was detected) such that, for example, a log 124A at node 120A discloses operations performed during the second duration of time that had not been performed during the first duration of time.

Various communications 197A-n can be utilized across the system 100A/100B, between data system 110 (and included components), nodes 120A-n, health assessment system 130, health monitoring component 132, incident component 140, administration system 145, customer service 148, process component 193, and computer system 180. Communications 197A-n can include notifications, instructions, status updates, selections, data, information (e.g., issue 157A-n occurring, current content 158A-n pertaining to issue 157A-n, event 160A relating to issue 157A-n, a gather logset 165A-n, a prior gather profile 135A-n and associated prior events 133A-n plus logsets 137A-n, a prior/current investigation 142A-n, an issue log 155, and such), and the like.

As shown in FIG. 1B, any of the components (e.g., data system 110, nodes 120A-n, health assessment system 130, health monitoring component 132, incident component 140, administration system 145, customer service system 148, process component 193 (as further described below), etc., can be communicatively coupled to a computer system 180. The computer system 180 can comprise a processor 182 and a memory 184, wherein the processor 182 can execute the various computer-executable components, functions, operations, etc., presented herein, e.g., any components in data system 110, any components in nodes 120A-n, any components in health assessment system 130, in administration system 145, customer service system 148, process component 193, and such. The memory 184 can be utilized to store the various computer-executable components, functions, code, etc., as well as information regarding any of an issue 157A-n, current content 158A-n pertaining to issue 157A-n, event 160A relating to issue 157A-n, a gather logset 165A-n, a prior gather profile 135A-n and associated prior events 133A-n plus logsets 137A-n, a prior/current investigation 142A-n, an issue log 155, vectors V₁₋ₙ, similarity indexes S₁₋ₙ, processes 194A-n (as further described below), historical data 191A-n, and suchlike.

As further shown, computer system 180 can include an input/output (I/O) component 186, wherein the I/O component 186 can be a transceiver configured to enable transmission/receipt of information and data between any of the components included in data system 110, administration system 145, customer service system 148, etc. I/O component 186 can be communicatively coupled to the remotely located devices and systems, e.g., administration system 145 and customer service system 148 implemented by entities 146A-n and 149A-n to interact with data system 110 regarding issues 157A-n. In an embodiment, I/O component 186 can be configured to transmit various communications 197A-n regarding issues 157A-n, profiles 135A-n, etc.

In an embodiment, the computer system 180 can further include a human-machine interface (HMI) 188 (e.g., a display, a graphical-user interface (GUI)) which can be configured to present various information including any of issue 157A-n, current content 158A-n pertaining to issue 157A-n, event 160A relating to issue 157A-n, a gather logset 165A-n, a prior gather profile 135A-n and associated prior events 133A-n plus logsets 137A-n, a prior/current investigation 142A-n, an issue log 155, vectors V₁₋ₙ, similarity indexes S₁₋ₙ, processes 194A-n, historical data 191A-n, communications 197A-n, etc., per the various embodiments presented herein. The HMI 188 can include an interactive display 189 to present the various information via various screens presented thereon, and further configured to facilitate input of information regarding an investigation 142A-n, etc.

System 100A/100B can further include a data historian 190 configured to compile historical data 191A-n (e.g., prior and/or current data/information/knowledge) regarding operation of data system 110 and respective components included therein, e.g., current/prior investigation 142A-n of an issue 157A-n, current content 158A-n pertaining to issue 157A-n, event 160A relating to issue 157A-n, a gather logset 165A-n, a prior gather profile 135A-n and associated prior events 133A-n plus logsets 137A-n, an issue log 155, vectors V₁₋ₙ, similarity indexes S₁₋ₙ, processes 194A-n, historical data 191A-n, and suchlike, to dynamically/automatically control data gathering for an issue 157A-n as part of an investigation 142A-n at data system 110.

System 100A/100B can further include a process component 193 and processes 194A-n. In an embodiment, processes 194A-n can include AI and ML processes which can be utilized to dynamically/automatically identify a gather profile 135A-n for implementation in investigating an issue 157A-n at data system 110, as further described.

It is to be appreciated that while process component 193 and processes 194A-n, data historian 190 and historical data 191A-n are depicted as being included/coupled to computer system 180, process component 193 and processes 194A-n, data historian 190 and historical data 191A-n can be located and implemented at any suitable location/activity/process undertaken across data system 110.

In FIG. 2, table 200 illustrates an example issue log, populated in accordance with one or more embodiments presented herein. As shown, example issue log 155 is populated with a current issue 157A, current content 158A pertaining to issue 157A, current investigative scopes 166A-n, one or more previously created profiles 135A-n, prior content 134A-n pertaining to the previously created profiles 135A-n (including any identified root cause), investigative scope 136A-n of the prior profile 135A-n, a prior issue 133A-n associated with a profile, and such. As shown, profiles 135A and 135B have single issues 133A and 133B respectively applied to them, while profile 135C is associated with prior issues 133C, 133D, and 133F such that while profile 135C was initially generated for prior issue 133C, during resolution/investigation of prior issues 133D and 133F a determination was made (e.g., by incident component 140) issues 133D and 133F had content sufficiently similar to content 134C such that profile 135C was successfully implemented to address the prior issues 133D and 133F, and prior issues 133D and 133F were further assigned to profile 135C. Also, prior issue 133C (and associated prior issues 133D and 133F) were deemed to relate to operation of certain nodes 120A-n, services 122A-n that were deemed YES to be of importance 161A, and similarly, current issue 157A/associated profile 135A is also defined as relating to operation of certain nodes 120A-n, services 122A-n, etc., that are YES, deemed to be of importance.

As shown, at 1, a current issue 157A having content 158A is identified (per FIG. 1B, step 1).

At 2, current content 158A is matched with prior content 134A, wherein content 134A is associated with prior profile 135A (per FIG. 1B, step 5).

At 3, a prior investigation leading to the creation of prior profile 135A has a prior scope of investigation 136A and a prior logset 137A of gathered information (per FIG. 1B, step 5).

At 4, an investigation 142A can be initiated wherein the gather scope 166A of the current investigation 142A can be based on the prior gather scope 136A of the matching profile 135A (per FIG. 1B, step 6).

At 5, in response to an investigation 142A resolving a current issue 157A, e.g., with an initial scope 166A or an extended scope 166A-1 (e.g., extended duration, extended number of nodes 120A-n, etc.), a new profile 135D can be generated for subsequent use in resolving a subsequent issue 157n. For example, current issue 157A becomes prior issue 133D, current content 158A becomes prior content 134D, current scope 166A/166A1 becomes prior scope 136D, etc. As previously mentioned, issue log 155 can be manually populated/compiled by any of system administrator 146A-n and/or customer service technician 149A-n, and further automatically populated by incident component 140 and/or health monitoring component 132 (e.g., in conjunction with process component 194/processes 194A-n).

It is to be appreciated that issue log 155 presents an example of information that can be compiled and presented, and any information, data, parameters, etc., suitable to enable matching of an issue 157A-n with a profile 135A-n can be compiled and populated in issue log 155. Further, profiles 135A-n can be as extensive as required to enable a myriad of issues 157A-n and 133A-n to be investigated with a defined scope 136A-n.

### 5. Application/Implementation of AI & ML

As mentioned, the various embodiments presented herein can utilize various AI/ML model/technology/technique/architecture (e.g., process component 193 implementing processes 194A-n). AI/ML technologies and techniques can be configured to determine information, make inferences, predictions, etc., regarding dynamically/automatically identifying/implementing a gather profile 135A-n having content 134A-n comparable to content 158A-n of a current issue 157A-n, and further generating a gather logset 165A-n based on the identified gather profile 135A-n.

Processes 194A-n can include AI, ML, and reasoning techniques/technologies that employ probabilistic and/or statistical-based analysis to prognose or infer an action that an entity desires to be automatically performed for carrying out various aspects thereof, e.g., dynamically identifying a gather profile 135A-n having content 134A-n that matches, or is sufficiently similar, to content 158A-n associated with a current issue 157A-n, and generating a gather logset 165A-n to enable investigation of current issue 157A-n, and suchlike, which as mentioned, can be facilitated via an automatic classifier system and process.

As used herein, the terms “predict”, “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis to prognose or infer an action that a user desires to be automatically performed (e.g., identifying a gather profile 135A-n for investigating a cause of a current issue 157A-n, and suchlike).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (as further described below). For example, SVM's are configured via a learning or training phase within a classifier constructor and feature selection module, e.g., included in process component 193. Thus, the classifier(s) can be used to automatically learn and perform a number of functions, including but not limited to determining according to predetermined criteria, e.g., automatically identifying a gather profile 135A-n pertaining to a current issue 157A-n, automatically implementing the identified gather profile 135A-n to investigate the current issue 157A-n and automatically find a cause for the current issue 157A-n, and suchlike.

In an example embodiment, processes 194A-n can be trained/fine-tuned with previously obtained/generated data (e.g., in historical data 191A-n, previously implemented gather profiles 135A-n, prior content 134A-n, prior scope 136A-n, prior issues 133A-n, prior gather logsets 137A-n, prior reviewed nodes 120A-n/services 122A-n, and such). Fine-tuning of a process 194A-n can comprise application, to processes 194A-n, of previously implemented gather logsets 137A-n, prior profiles 135A-n, prior content 134A-n, and suchlike. Processes 194A-n can be correspondingly adjusted by the ability of the processes 194A-n (process component 193, and any associated component across data system 110 utilizing processes 194A-n) to successfully/or unsuccessfully determine any of a previously defined gather logset 137A-n, gather profile 135A-n, and suchlike, that corresponds to, satisfies, or substantially satisfies, a similarity criterion pertaining to/determined for a current issue 157A-n for which a gather logset 165A-n is being configured. For example, weightings in the process 194A-n are adjusted by application of the ability of the process 194A-n to accurately determine a previously defined profile 135A-n, and associated gather logset 137A-n, that is suitable for application with a current issue 157A-n, and such. During training, prior decisions, prior observations, determinations, etc., can be applied to the processes 194A-n, enabling the processes 194A-n to be trained regarding correctly identifying a prior defined profile 135A-n, and associated gather logset 137A-n, that is suitable for application with a current issue 157A-n, to be implemented on data system 110. Accordingly, when new information is provided (e.g., result of investigating an issue 157A-n, result of application of gather logset 165A-n/137A-n, newly received content 158A-n, and suchlike), processes 194A-n can be retrained accordingly.

In an example, processes 194A-n can be configured to be implemented by the incident component 140 to assist with defining a new logset 165A/scope 166A (based on profiles 135A-n) to resolve issue 157A. Processes 194A-n can be utilized to review previously defined profiles 135A-n, prior issues 133A-n, prior content 134A-n, etc., to determine, a logset 137A and scope 136A to be implemented to resolve current issue 157A.

It is to be appreciated that the various processes 194A-n and operations presented herein are simply examples of respective AI and ML operations and techniques, and any suitable technology can be utilized in accordance with the various embodiments presented herein. In an example embodiment, process component 193/processes 194A-n can be applied to any of previously implemented gather profiles 135A-n, prior gather logsets 137A-n, prior issues 133A-n, prior content 134A-n, and such. Wherein, process component 193/processes 194A-n can include a vector component to apply any suitable vectoring technology, such as, in a non-limiting list, bag of words (BOW) text vectors, Euclidean distance, cosine similarity, vector representation via term frequency-inverse document frequency (tf-idf) capturing term/token frequency (e.g., common terms across prior/current/future knowledge), neural network embedding layer vector representation of terms/categories (e.g., common terms having different tense), a transformer neural network, bidirectional and auto-regressive transformer (BART) model architecture, a bidirectional encoder representation from transformers (BERT) model, long short term memory network (LSTM) operation(s), a sentence state LSTM (S-LSTM), a deep learning algorithm, a sequential neural network, a sequential neural network that enables persistent information, a recurrent neural network (RNN), a convolutional neural network (CNN), a neural network, capsule network, a machine learning algorithm, a natural language processing (NLP) technique, sentiment analysis, bidirectional LSTM (BiLSTM), stacked BiLSTM, regular pattern expression matching, and suchlike. Language models, LSTMs, BARTs, etc., can be formed with a neural network that is highly complex, for example, comprising billions of weighted parameters.

Accordingly, in an embodiment, implementation of data system 110 and included/associated components, with processes 194A-n, enables natural language processing (NLP) (e.g., utilizing vectors) to identify a previously configured gather profile 135A-n and gather logsets 137A-n that is/are comparable/applicable to an issue 157A-n that is to be investigated, e.g., by system administrator 146A-n, service tech 149A-n, etc.

During application of processes 194A-n, vector representations V₁₋ₙ can be applied to any of prior profiles 135A-n, current issue 157A, prior issues 133A-n, current content 158A and prior content 134A-n, etc., e.g., in historical data 191A-n, etc., such that vector similarity operations (e.g., vector clustering/distancing or other similarity criterion) can be applied to recommend a prior profile 135A-n for implementation in investigating current issue 157A. The degree of similarity (e.g., via similarity indexes S₁₋ₙ, a.k.a., similarity criterions) between respective information can be determined, for example, based on a threshold reflecting a proximity of a first vector generated from prior content 134A-n to a second vector generated from current content 158A to enable identifying a prior profile 135A-n for implementation in resolving issue 157A, e.g., based on similarity of current content 158A to prior content 134A.

### 4. Methods for Configuring and Implementing Gather Profiles

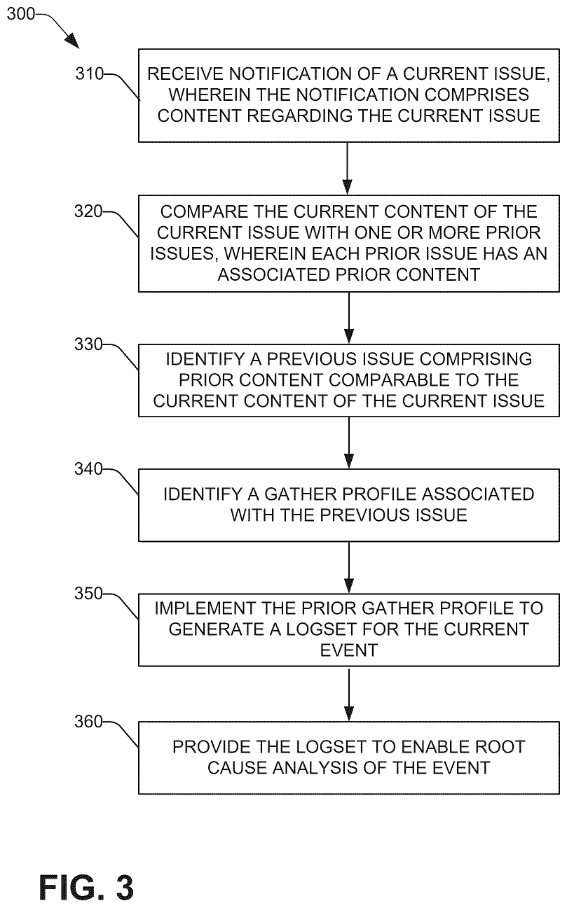

In FIG. 3, via flowchart 300, presents an example computer-implemented method for dynamically implementing a gather profile and associated investigative scope to address an issue, in accordance with one or more embodiments.

At 310, a notification (e.g., notification 197N) can be received at an incident component (e.g., incident component 140) regarding a current issue (e.g., issue 157A) has been detected at a system (e.g., at one or more nodes 120A-n, services 122A-n, and the like, in data system 110). The issue 157A can have an associated content (e.g., content 158A) comprising one or more signatures, configurations, patterns of operation/incident, etc.

At 320, the incident component can be further configured to compare the content (e.g., content 158A) of the current issue (e.g., issue 157A) with content (e.g., content 134A-n) collected regarding investigation of prior issues (e.g., prior issues 133A-n) to enable a previously defined gather profile (e.g., gather profiles 135A-n) to be identified for implementation in investigation (e.g., investigation 142A) of the current issue.

At 330, the incident component can be further configured to identify a prior issue comprising prior content comparable to the current content of the current issue.

At 340, the incident component can be further configured to identify a prior profile (e.g., prior gather profile 135A-n) associated with the prior issue comprising prior content comparable to the current content of the current issue.

At 350, the incident component can be further configured to implement the prior profile to assist in investigating a cause of the current issue. As previously described, the prior profile can have a scope (e.g., scope 136A-n) defining a scope of investigation to be implemented in resolving the current issue.

At 360, the incident component can be further configured to implement a root cause investigation regarding the current issue in an attempt to address/solve the issue.

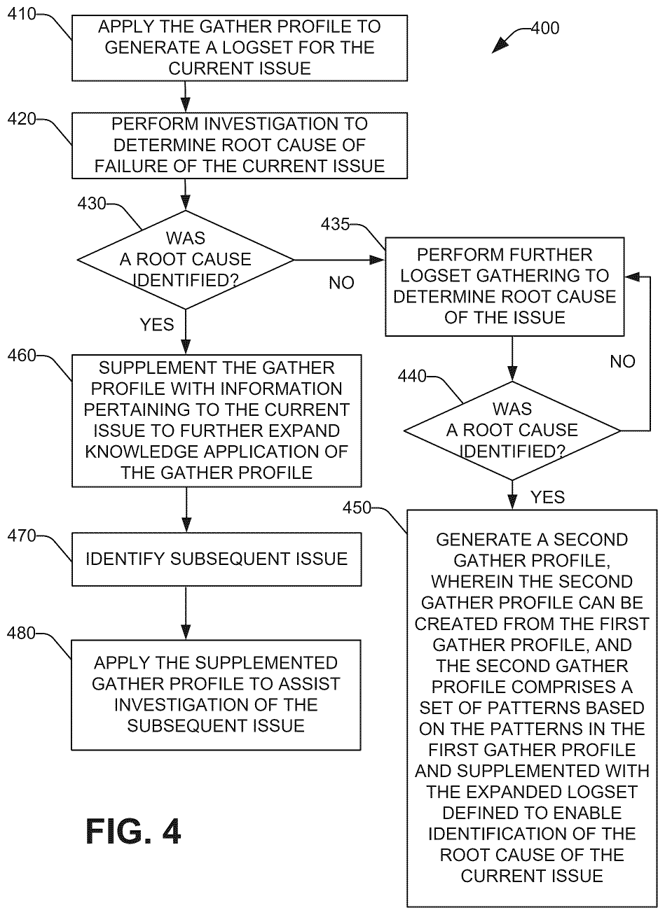

In FIG. 4, via flowchart 400, presents an example computer-implemented method for dynamically implementing a gather profile and associated investigative scope to address an issue, in accordance with one or more embodiments.

At 410, an incident component (e.g., incident component 140) can be configured to implement a gather profile (e.g., a gather profile 135A) to generate a logset (e.g., logset 165A) configured to gather information regarding a current issue (e.g., issue 157A). As previously mentioned, the implemented gather profile can be identified (e.g., by incident component 140) based on content (e.g., current content 158A) available for the current issue, matches, or substantially matches, prior content (e.g., prior content 134A) associated with a prior issue (e.g., prior issue 133A). The gather profile can further include an investigative scope (e.g., scope 136A) generated during investigation of the prior issue, wherein the scope defines/limits the degree of investigation to be performed in resolving the current issue.

At 420, the incident component can be further configured to implement the scope of the identified prior profile and apply it to the current system (e.g., nodes 120A-n, services 122A-n, and the like). As previously mentioned, rather than the investigation generates a conventional gather logset, the scope can limit the investigation of the current issue to aspects, devices, systems, components, timing, etc., as defined in the applied scope.

At 430, a determination (e.g., by entities 146A-n, 149A-n) can be made regarding the effectiveness of the logset captured with implementation of the scope in resolving the cause of the current issue. In response to a determination that YES, the cause of the issue was identified, method 400 can advance to step 460. At 460, the profile (e.g., gather profile 135A) implemented to assist in investigating the current issue can be supplemented with information, content, etc., associated with the current issue. Supplementing the profile further expands the knowledge/content defined for the profile with the content associated with the current issue, thereby further expanding the knowledge base of the profile to facilitate subsequent determination of the profile being applicable to a future issue.

AT 470, a subsequent issue (e.g., issue 157B) can be identified (e.g., by HMC 132).

At 480, investigation of the cause of the subsequent issue can be performed, wherein the implementation of the gather profile (e.g., supplemented gather profile 135A) can be utilized to identify a cause of the subsequent issue.

At 430, in response to a determination that NO a root cause of the issue was not identified with the current logset/scope of investigation, method 400 can advance to step 435, whereupon the current logset/scope can be extended to capture further information (e.g., based on time, operation of a component, device, etc.) potentially pertaining to resolving the current issue. For example, rather than generating a logset defined by a first time window (e.g., x minutes after the issue arose), the first time window of the logset gather can be extended (e.g., to x+n minutes after the issue arose), other devices/components in the system (e.g., in data system 110) that were not initially accessed during the initial implementation of the initial logset gather operation initial scope can be further included in an expanded logset gather operation, and suchlike.

At 440, a determination can be made regarding whether information in the expanded logset gather has enabled the issue to be resolved. At 440, in response to a determination that YES, a root cause was identified, method 400 can advance to 450, whereupon a second gather profile (e.g., gather profile 135D) can be generated. In an embodiment, the second gather profile can be generated from the first gather profile and further includes the additional content, etc., as applied/acquired during the expanded logset gather/investigation. The second gather profile can be added to the issue log (e.g., issue log 155), rendering the second gather profile to be available for generation of a future logset when investigating a future issue.

At 440, in response to a determination that NO, a root cause has not been identified, method 400 can return to 435 for the current scope of the currently applied logset gather operation to be further/continually expanded/extended as required to enable the root cause to be identified. At step 440, once the cause has been subsequently identified, method 400 can advance to 450, as previously described.

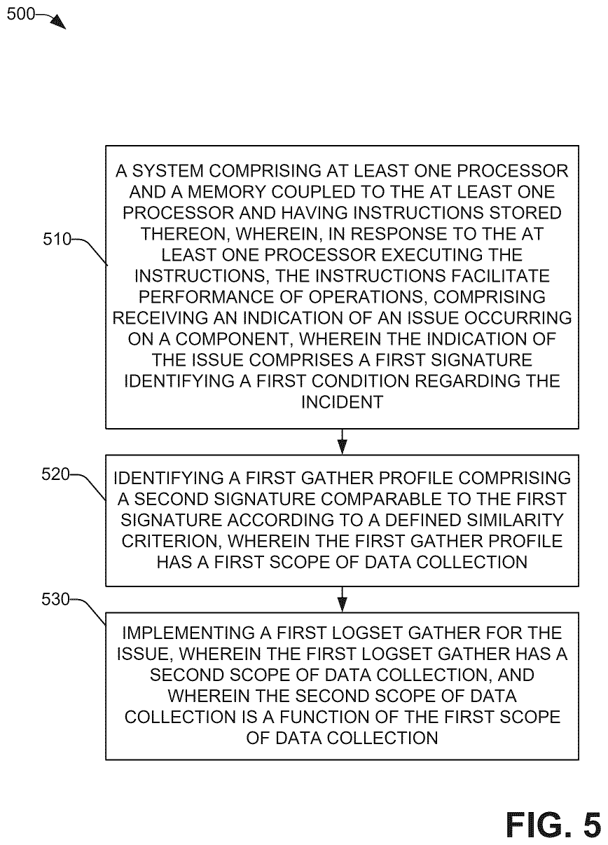

FIG. 5, via flowchart 500, presents an example computer-implemented method for automatically and dynamically implementing one or more gather profiles to enable identifying a root cause of an issue, in accordance with an embodiment. At 510, method 500 can be performed by a system (e.g., health assessment system 130) comprising at least one processor (e.g., processor 182A-n) and a memory (e.g., memory 184A-n) coupled to the at least one processor and having instructions stored thereon, wherein, in response to the at least one processor executing the instructions, the instructions facilitate performance of operations comprising receiving an indication (e.g., notification 197A) of an issue (e.g., issue 157A) occurring on a component (e.g., node 120A-n), wherein the indication of the issue comprises a first signature (e.g., first content 158A) identifying a first condition regarding the incident. At 520, method 500 can further comprise identifying a first gather profile (e.g., gather profile 135A-n) comprising a second signature (e.g., second content 134A-n) comparable to the first signature according to a defined similarity criterion, wherein the first gather profile has a first scope (e.g., prior scope 136A-n) of data collection. At 530, method 500 can further comprise implementing a first logset gather (e.g., gathering of logset 165A) for the issue, wherein the first logset gather has a second scope (e.g., second scope 166A-n) of data collection, and wherein the second scope of data collection is a function of the first scope of data collection.

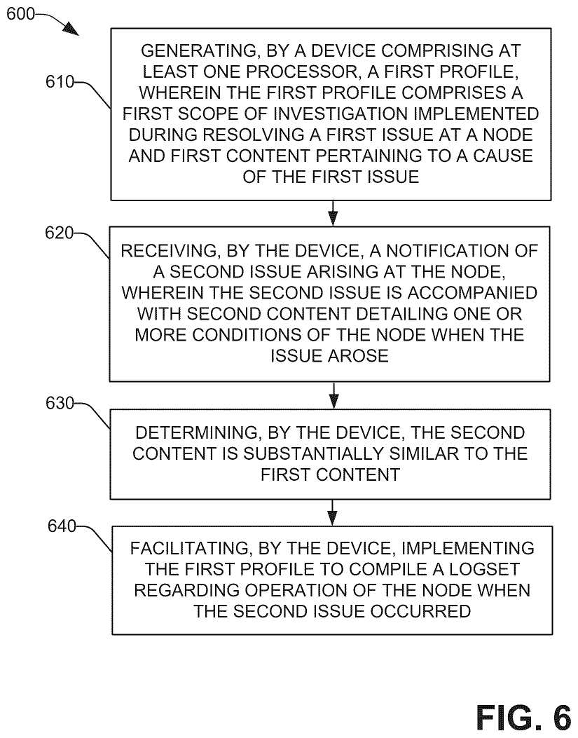

FIG. 6, via flowchart 600, presents an example computer-implemented method for automatically and dynamically implementing one or more gather profiles to enable identifying a root cause of an issue, in accordance with an embodiment. At 610, method 600 can comprise generating, by a device (e.g., health assessment system 130) comprising at least one processor (e.g., processor 182A-n), a first profile (e.g., prior profile 135A-n), wherein the first profile comprises a first scope (e.g., prior scope 136A-n) of investigation (e.g., investigation 142A-n) implemented during resolving a first issue (e.g., prior issue 133A-n) at a node (e.g., a node 120A-n) and first content (e.g., prior content 134A-n) pertaining to a cause (e.g., in prior content 134A-n) of the first issue. At 620, method 600 can further comprise receiving, by the device, a notification (e.g., notification 197A-n) of a second issue (e.g., issue 157A) arising at the node, wherein the second issue is accompanied with second content (e.g., content 158A-n) detailing one or more conditions of the node when the issue arose. At 630, method 600 can further comprise determining, by the device, the second content is substantially similar to the first content. At 640, method 600 can further comprise facilitating, by the device, implementing the first profile to compile a logset (e.g., logset 165A) regarding operation of the node when the second issue occurred.

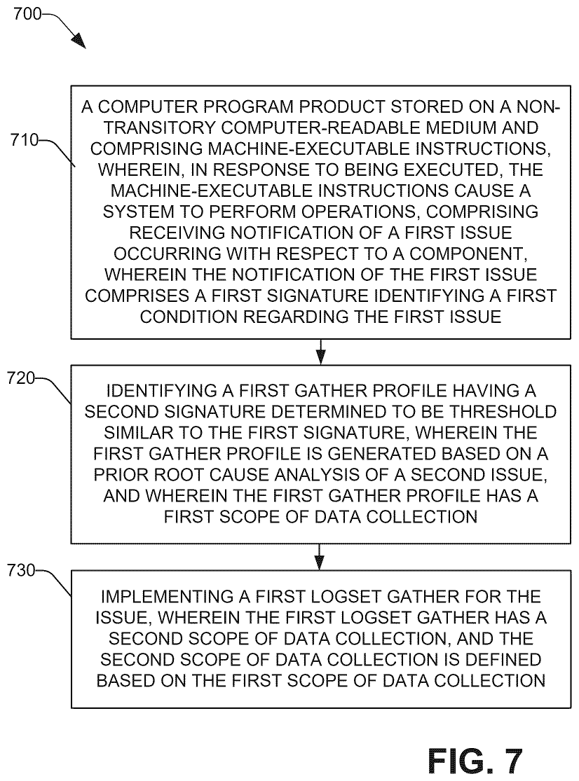

FIG. 7, via flowchart 700, presents an example computer-implemented method for automatically and dynamically implementing one or more gather profiles to enable identifying a root cause of an issue, in accordance with an embodiment. At 710, method 700 can be performed with a computer program product stored on a non-transitory computer-readable medium (e.g., memory 184A-n) and comprising machine-executable instructions, wherein, in response to being executed (e.g., by processor 182A-n), the machine-executable instructions cause a system (e.g., health assessment system 130) to perform operations, comprising receiving notification (e.g., notification 197A) of a first issue (e.g., issue 157A) occurring with respect to a component (e.g., node 120A-n), wherein the notification of the first issue comprises a first signature (e.g., first content 158A-n) identifying a first condition regarding the first issue. At 720, method 700 can further comprise identifying a first gather profile (e.g., gather profile 135A-n) having a second signature (e.g., prior content 134A-n) determined to be threshold similar (e.g., comparable, similar, substantially similar) to the first signature, wherein the first gather profile is generated based on a prior root cause analysis (e.g., prior investigation 142A-n) of a second issue (e.g., prior issue 133A-n), and wherein the first gather profile has a first scope (e.g., prior scope 136A-n) of data collection. At 730, method 700 can further comprise implementing a first logset gather (e.g., gathering of logset 165A) for the issue, wherein the first logset gather has a second scope (e.g., current scope 166A-n) of data collection, and the second scope of data collection is defined based on the first scope of data collection.

### 6. Example Environments of Use

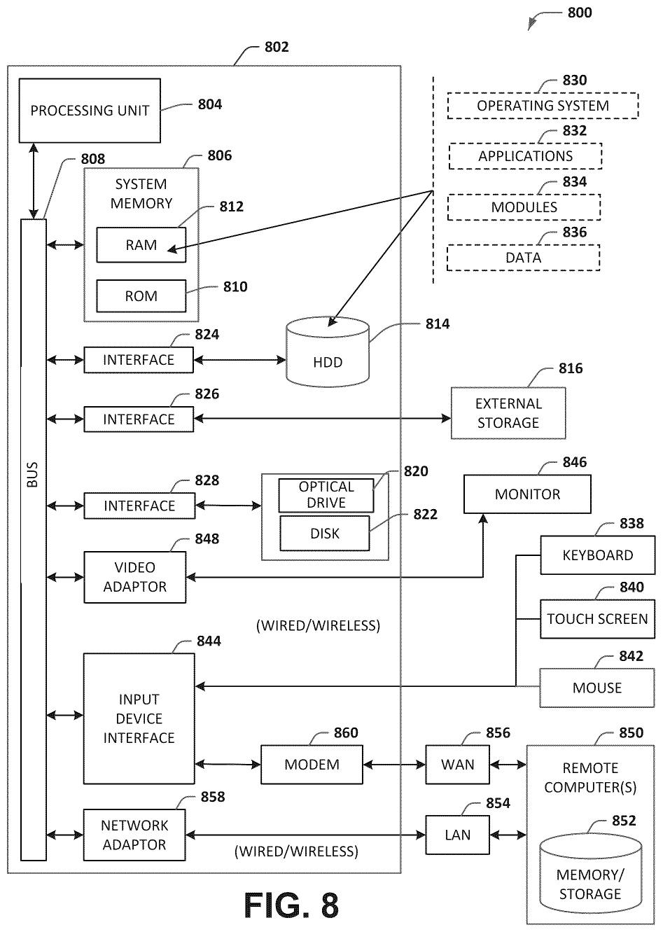

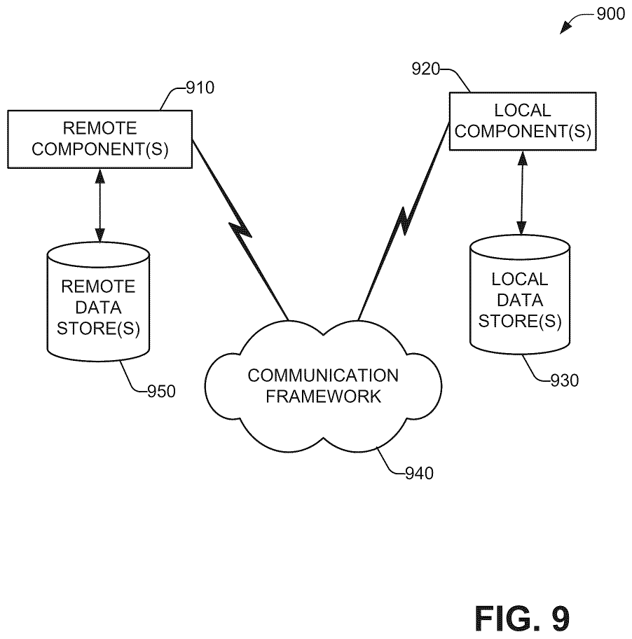

Turning next to FIGS. 8 and 9, a detailed description is provided of additional context for the one or more embodiments described herein with FIGS. 1-7.

In order to provide additional context for various embodiments described herein, FIG. 8 and the following discussion are intended to provide a brief, general description of a suitable computing environment 800 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 8, the example environment 800 for implementing various embodiments of the aspects described herein includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors and may include a cache memory. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), one or more external storage devices 816 (e.g., a magnetic floppy disk drive (FDD) 816, a memory stick or flash drive reader, a memory card reader, etc.) and an optical disk drive 820 (e.g., which can read or write from a CD-ROM disc, a DVD, a BD, etc.). While the internal HDD 814 is illustrated as located within the computer 802, the internal HDD 814 can also be configured for external use in a suitable chassis (not shown). Additionally, while not shown in environment 800, a solid-state drive (SSD) could be used in addition to, or in place of, an HDD 814. The HDD 814, external storage device(s) 816 and optical disk drive 822 can be connected to the system bus 808 by an HDD interface 824, an external storage interface 826 and an optical drive interface 828, respectively. The interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 812, including an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the. NET framework, for applications 832. Runtime environments are consistent execution environments that allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and settings for an application.

Further, computer 802 can comprise a security module, such as a trusted processing module (TPM). For instance with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 1394 serial port, a game port, a USB port, an IR interface, a BLUETOOTH® interface, etc.

A monitor 846 or other type of display device can be also connected to the system bus 808 via an interface, such as a video adapter 848. In addition to the monitor 846, a computer typically includes other peripheral output devices (not shown), such as speakers, printers, etc.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 852 is illustrated. The logical connections depicted include wired/wireless connectivity to a local area network (LAN) 854 and/or larger networks, e.g., a wide area network (WAN) 856. Such LAN and WAN networking environments are commonplace in offices and companies, and facilitate enterprise-wide computer networks, such as intranets, all of which can connect to a global communications network, e.g., the internet.

When used in a LAN networking environment, the computer 802 can be connected to the local network 854 through a wired and/or wireless communication network interface or adapter 858. The adapter 858 can facilitate wired or wireless communication to the LAN 854, which can also include a wireless access point (AP) disposed thereon for communicating with the adapter 858 in a wireless mode.

When used in a WAN networking environment, the computer 802 can include a modem 860 or can be connected to a communications server on the WAN 856 via other means for establishing communications over the WAN 856, such as by way of the internet. The modem 860, which can be internal or external and a wired or wireless device, can be connected to the system bus 808 via the input device interface 844. In a networked environment, program modules depicted relative to the computer 802 or portions thereof, can be stored in the remote memory/storage device 852. It will be appreciated that the network connections shown are example and other means of establishing a communications link between the computers can be used.

When used in either a LAN or WAN networking environment, the computer 802 can access cloud storage systems or other network-based storage systems in addition to, or in place of, external storage devices 816 as described above. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 9, an illustrative cloud computing environment 900 is depicted. FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising
at least one processor; and
a memory coupled to the at least one processor and having instructions stored thereon, wherein, in response to the at least one processor executing the instructions, the instructions facilitate performance of operations, comprising:
receiving an indication of an issue occurring on a component, wherein the indication of the issue comprises a first signature identifying a first condition regarding the incident;
identifying a first gather profile comprising a second signature comparable to the first signature according to a defined similarity criterion, wherein the first gather profile has a first scope of data collection; and
implementing a first logset gather for the issue, wherein the first logset gather has a second scope of data collection, and wherein the second scope of data collection is a function of the first scope of data collection.

2. The system of claim 1, wherein the component is a node located in a data server.

3. The system of claim 2, wherein the first gather profile is generated based on a prior issue determined to have occurred at the node.

4. The system of claim 2, wherein the first gather profile is generated based on a prior issue determined to have occurred at a service hosted on the node.

5. The system of claim 1, wherein the first gather profile identifies at least one action to be performed during implementation of the first logset gather during investigation of the incident.

6. The system of claim 5, wherein the operations further comprise:
determining that implementation of the first logset gather failed to determine a root cause of the incident;
generating a second logset gather having a third scope of data collection, wherein the third scope of data collection is an expansion of scope associated with the second scope of data collection; and
implementing the second logset gather for the incident.

7. The system of claim 6, wherein the second scope of data collection comprises a first duration of time based on a first time when the incident occurred, wherein the third scope of data collection comprises a second duration of time based on a second time when the incident occurred, and wherein the second duration of time exceeds the first duration of time.

8. The system of claim 6, wherein the second scope of data collection comprises a first collection of devices to be investigated, and wherein the first collection of devices comprises at least one node, at least one service, at least one configuration, or at least one core.

9. The system of claim 8, wherein the third scope of data collection comprises the second scope of data collection, and wherein the at least one node, the at least one service, the at least one configuration, or the at least one core are not within scope of the second scope of data collection.

10. A computer-implemented method, comprising:
generating, by a device comprising at least one processor, a first profile, wherein the first profile comprises a first scope of investigation implemented during resolving a first issue at a node and first content pertaining to a cause of the first issue;
receiving, by the device, a notification of a second issue arising at the node, wherein the second issue is accompanied with second content detailing one or more conditions of the node when the issue arose;
determining, by the device, the second content is substantially similar to the first content; and
facilitating, by the device, implementing the first profile to compile a logset regarding operation of the node when the second issue occurred.

11. The computer-implemented method of claim 10, further comprising reviewing, by the device, the logset to determine a root cause of the second issue.

12. The computer-implemented method of claim 11, further comprising, in the event of identifying, by the device, the root cause of the second issue, adding, by the device, the second content of the second issue to information pertaining to the first profile.

13. The computer-implemented method of claim 11, further comprising, in the event of identifying, by the device, the root cause of the second issue, generating, by the device, a second profile, wherein the second profile comprises information representative of the second scope of investigation, the second issue, and the root cause of the second issue.

14. The computer-implemented method of claim 11, further comprising, in the event of not identifying, by the device, the root cause of the second issue, generating, by the device, a second scope of investigation, wherein the second scope increases, relative to the first scope of investigation, at least one of a duration of time of investigation, number of nodes to be reviewed during investigation, number of services to be reviewed during investigation, number of configurations to be reviewed during investigation, number of cores to be reviewed during investigation, or number of logs to be reviewed during investigation.

15. The computer-implemented method of claim 10, wherein the first issue and the second issue occurred on a same node located in a data server.

16. The computer-implemented method of claim 10, wherein the first scope of the first profile is utilized to compile the logset regarding operation of the node at a time when the second issue occurred.

17. A computer program product stored on a non-transitory computer-readable medium and comprising machine-executable instructions, wherein, in response to being executed, the machine-executable instructions cause a system to perform operations, comprising:
receiving notification of a first issue occurring with respect to a component, wherein the notification of the first issue comprises a first signature identifying a first condition regarding the first issue;
identifying a first gather profile having a second signature determined to be threshold similar to the first signature, wherein the first gather profile is generated based on a prior root cause analysis of a second issue, and wherein the first gather profile has a first scope of data collection; and
implementing a first logset gather for the issue, wherein the first logset gather has a second scope of data collection, and the second scope of data collection is defined based on the first scope of data collection.

18. The computer program product according to claim 17, wherein the component is a node located in a data server.

19. The computer program product according to claim 17, wherein the second issue occurred on at least one of a node in a data network system or a service hosted on the node in the data network system.

20. The computer program product according to claim 17, wherein the first scope of data collection comprises at least one of a one node, a service, a configuration, or a core reviewed during the prior root cause analysis of the second issue.
